(19) United States
(12) Patent Application Publication
(10) Pub. No.: US 2026/0177498 A1
(43) Pub. Date: Jun. 25, 2026

(54) METHOD AND SYSTEM FOR SURFACE INSPECTION OF A CURED COMPOSITE PART COMPRISING GLASS FIBERS AND CARBON FIBERS, IN PARTICULAR OF AN AIRCRAFT

(71) Applicant: Airbus SAS, BLAGNAC (FR)

(72) Inventors: Liu MENG, TAUFKIRCHEN (DE); Mohamed SAYEH, TAUFKIRCHEN (DE)

(21) Appl. No.: 19/423,262

(22) Filed: Dec. 17, 2025

(30) Foreign Application Priority Data
Dec. 19, 2024 (EP) 24221591.1

(51) Int. Cl. G01N 21/88; G01N 21/3563; H04N 23/20

(52) U.S. Cl. CPC G01N 21/8806; G01N 21/3563; H04N 23/20; G01N 2021/8822; G01N 2201/0636

(57) ABSTRACT

A method for surface inspection of a cured composite part comprising glass fibers and carbon fibers, in particular of an aircraft, by illuminating a surface of the composite part with infrared light from an IR-light source, and capturing an image of the surface. The IR-light source is arranged so generated infrared light hits the surface at a first angle α to provide a dark field illumination, and the camera is arranged to point at the surface at a second angle β to capture the image of the dark field illuminated surface. The captured image is evaluated with regard to brightness and contrast to detect one or more glass fiber layers on top of one or more carbon fiber layers within the composite part.

### CROSS-REFERENCES TO RELATED APPLICATIONS

This application claims the benefit of European Patent Application Number 24 221 591.1 filed on Dec. 19, 2024, the entire disclosure of which is incorporated herein by way of reference.

### FIELD OF THE INVENTION

The invention relates to a method for surface inspection of a cured composite part comprising glass fibers and carbon fibers. Further, the invention relates to a system for surface inspection of a cured composite part comprising glass fibers and carbon fibers. In addition, the invention relates to the use of an infrared (IR-) light source and a camera in a method for surface inspection of a cured composite part. The method and the system are in particular suitable for inspecting composite parts of an aircraft.

### BACKGROUND OF THE INVENTION

Many composite parts of an aircraft comprise layers of carbon fibers and layers of glass fibers, i.e., such parts are comprising CFRP (Carbon Fiber Reinforced Polymer) and GFRP (Glass Fiber Reinforced Polymer). For example, one or more glass fiber layers may cover carbon fiber layers. The glass fiber layers are in particular used to avoid a direct contact between the carbon fibers and aluminum when the composite part is attached to another part made of aluminum, which would lead to corrosion.

However, it may happen that in a cured composite part, a layer of glass fibers is missing, or that a layer of glass fibers is at a position where it should not be. Further, e.g., two layers of glass fibers may be at a position where only one layer of glass fibers should be. These are examples of defects of the cured composite part, which need to be detected.

According to the state of the art, the existence of glass fibers can be found by active thermography, which uses a bolometer with additional excitation sources like a halogen lamp or high-power LED flashlight. However, this requires long data acquisition time. Moreover, it often heats up the inspected object by a few degrees. This is not optimal in use cases that require a relative short acquisition time and a minimum impact on high-value objects like e.g. aircraft flaps or other parts of an aircraft.

It is an object of the invention to provide a method and a system for surface inspection of a cured composite part comprising glass fibers and carbon fibers, which detects defects related to the position and number of glass fiber layers faster, with high accuracy, and with a reduced impact on the cured composite part.

### SUMMARY OF THE INVENTION

The object may be solved by a method for surface inspection of a cured composite part comprising glass fibers and carbon fibers, in particular of an aircraft, comprising the steps: illuminating a surface of a composite part to be inspected with infrared light emitted from an IR light source and capturing an image of the surface with a camera, wherein IR light source is arranged so that the infrared light hits the surface at a first angle to provide a dark field illumination of the surface, and wherein the camera is arranged so that it points at the inspected surface at a second angle to capture the image of the dark field illuminated surface; and detecting one or more glass fiber layers on top of one or more carbon fiber layers within the composite part by evaluating the captured image with regard to brightness and contrast.

The invention leads to strong contrast between GFRP and CFRP layers and a short inspection time. In particular, only one exposure at one location is needed. Moreover, it is not necessary to wait for excitation source phasing.

Preferably, the IR light source and the camera are arranged in relation to the inspected surface in such a way that the infrared light and the camera are directed at the surface from the same direction.

For example, the first angle at which the infrared light hits the surface is between 20 and 50 degrees.

Preferably, the first angle at which the infrared light hits the surface is between 25 and 35 degrees.

Most preferably, the first angle at which the infrared light hits the surface is about (+/−10%) 30 degrees.

For example, the second angle at which the camera points at the surface is between 30 and 60 degrees.

Preferably, the second angle at which the camera points at the surface is between 40 and 50 degrees

Most preferably, the second angle at which the camera points at the surface is about 45 degrees.

Preferably, the infrared light hits the surface from the same direction from which the camera is pointing at the surface.

Preferably, the first angle is different from the second angle.

In particular, the first angle is smaller than the second angle.

Preferably, the infrared light emitted by the IR-light source forms a light beam emitted in a beam direction and comprising a spatial component that extends perpendicular to the beam direction and parallel to the inspected surface.

Preferably, the camera has a field of view and/or line scan direction that extends parallel to that spatial component of the light beam.

Preferably, the infrared light is at the boundary to visible light.

Preferably, the infrared light has a wavelength of about 850 nm.

Preferably, the camera is a monochrome camera.

Preferably, the camera is an infrared camera.

Preferably, the camera is a CMOS camera.

Preferably, the camera is a line scan camera.

Preferably, the camera comprises a band filter which allows a band of wavelength around 850 nm pass through.

It is also possible that the camera does not comprise a filter.

Thus, an even higher scanning speed for scanning the inspected surface can be achieved.

However, the camera can be configured as a matrix camera as well. This may lead to specific advantages, depending on the application.

Preferably, the IR light source and the camera are positioned above a top edge of the component during inspection, and a mirror is positioned on one or both sides of the component, so that it deflects the infrared light to strike the surface (at the first angle α, the camera being directed to the mirror to point at the surface at the second angle β.

According to another aspect of the invention, a system for surface inspection of a cured composite part comprising glass fibers and carbon fibers in particular of an aircraft is provided, comprising an IR light source and a camera, both configured to perform the method according to the invention.

According to a further aspect of the invention, the use of an IR light source and a camera in a method according to the invention is provided

The strong contrast is due to the fact that GFRP is relatively highly reflective under the dark field an IR light condition according to the invention.

Further, no over-or underexposure is in the image due to an even distribution of light. The system can be positioned relatively close to the surface of the part or object, so that the external light source will not much influence the data quality.

Furthermore, a big and scalable field of view with high spatial resolution is achieved. For example, the system can cover 100 mm to 500 mm. Moreover, the invention leads to a low power consumption, a safe use by the operator, and a compact system which is easy to integrate.

### BRIEF DESCRIPTION OF THE DRAWINGS

In the following, embodiments of the invention are described in more detail with reference to the accompanying drawings, in which

FIG. 1 depicts a schematic side view of a system when performing the method according to a first embodiment of the invention;

FIG. 2 depicts a schematic side view of the system when performing the method according to a second embodiment of the invention; and

FIG. 3 depicts a schematic front view of the system shown in FIG. 2 when performing the method.

### DETAILED DESCRIPTION OF THE PREFERRED EMBODIMENTS

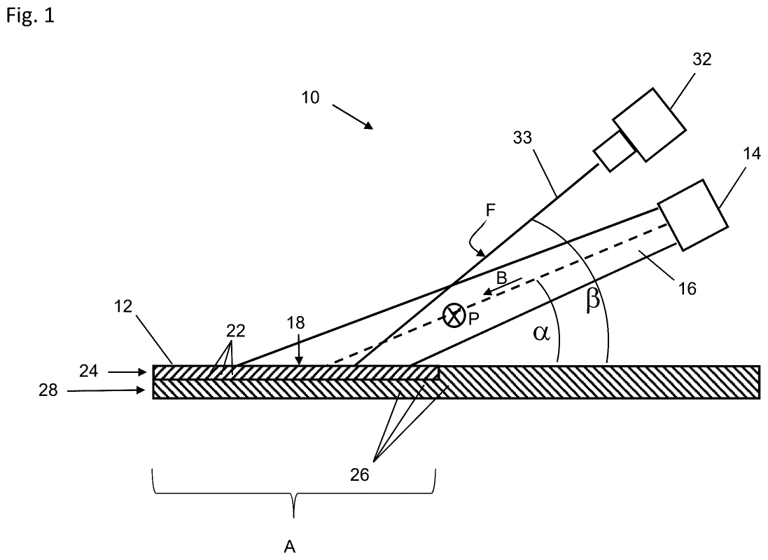

With reference to FIG. 1, a method according to a preferred embodiment of the invention and a preferred system 10 used in the method is described.

The system 10 is designed for surface inspection of a cured composite part 12 of an aircraft. It comprises an infrared or IR-light source 14 which emits infrared (IR) light 16 to illuminate a surface 18 of the composite part 12. The composite part 12 comprises glass fibers 22, which are e.g. arranged as one or more glass fiber layers 24 within composite part 12. Further, the composite part 12 comprises carbon fibers 26, e.g. being arranged as one or more carbon fiber layers 28. In this example, one glass fiber layer 24 is positioned above one carbon fiber layer 26 in an area A of the composite part 12, whereas in other areas is only the glass fiber layer 26.

In other examples, the composite part is made of carbon fibers only. In this case the system 10 is used to find glass or glass fibers or other foreign objects which should not be there. The system might also be used to inspect composite parts of pure glass fibers.

The infrared light source or IR-light source 14 is arranged above the inspected surface 18 in such a way that the generated infrared light 16 hits the surface 18 at a first angle α to provide a dark-field illumination of surface 18.

A camera 32 which is preferably a high-resolution monochrome camera, is positioned as well above surface 18 in a way such that its viewing direction 33 or optical axis points at the surface 18 at a second angle β to capture an image of the surface 18 when it is illuminated with the infrared light 16.

The infrared light source 14 and the camera 32 are arranged at the same side of the inspected surface 18. That means they are arranged in relation to the inspected surface 18 in such a way that the infrared light 16 and the camera 32 are directed at the surface 18 from the same direction, i.e., in FIG. 1 from the right side. In this way, the infrared light 16 which forms a light beam having a beam direction B illuminates the surface 18 at inclination angle α from the same direction from which camera 32 is viewing the illuminated surface 18 at the inclination angle β.

During the inspection of the cured composite part 12, infrared light source 14 and high-resolution camera 32 are positioned relative to the surface 18 to be inspected as described above, wherein infrared light source 14 illuminates the surface 18 with a dark field illumination and camera 32 captures images of the dark field illuminated surface 18 as described above.

Preferably, infrared light source 14 and camera 32 are moved together relative to surface 18 in order to scan it. Both together may form an end-effector unit configured for being mounted to a robot arm for being moved and scanning surface 18.

The image captured by camera 32 is evaluated with regard to brightness and/or contrast. In this way, one or more glass fiber layers 24 which are positioned on one or more of carbon fiber layers 26 are detected.

The captured image is evaluated with regard to image areas or pixels of different brightness and/or contrast to detect glass fibers within the composite part 12. Preferably, image data generated by camera 32 is automatically evaluated by an evaluation system not shown in the figures.

The method and system 10 described here uses the difference in the light absorption rate and ways of reflection between the glass fibers 22 and the carbon fibers 26. Both, the infrared light 16 and the tilt angle α at which the infrared light 16 hits or strikes the surface 18 emphasizes this difference. The glass fibers 22 or glass fiber layer(s) 24 absorb less infrared light than the carbon fibers 26 or carbon fiber layer(s) 28.

Camera 32 is preferably a CMOS camera. The CMOS (complementary metal oxide semiconductor) sensor of camera 32 configured as CMOS camera has a relatively high quantum efficiency at the NIR range. In addition, it is relatively cheap and easy to integrate. Considering all factors, a wavelength of 850 nm is most preferably selected for the IR light source, and monochrome CMOS camera is most preferably used.

Most preferably, the camera 32 is configured as a line scan camera. This relates in an even higher speed of the surface inspection. But nevertheless, a matrix camera may be used as well.

In particular, the method and system 10 make use of the fact that the glass fibers 22 reflect the infrared light 16 more diffused than the carbon fibers 26. This difference contrasts the image in near infrared (NIR) and shortwave infrared (SWIR).

The inclination angle α at which IR light beam 16 hits the surface 18 is most preferably around 30°. However, it may also deviate from that ideal value and be in a range between 25 and 35° or between 20 and 50°. The inclination angle β at which the camera 32 is aimed at the surface 18 is most preferably around 45°. But it may also deviate from that the value and be in range between 40 and 50° or between 30 and 60°. The angle β is usually greater than the angle α for achieving good results.

The infrared light 16 forming a light beam having beam direction B and emitted by IR light source 14 may extend in a direction P which is perpendicular to the direction B of the light beam 16 and parallel to the inspected surface 18. Camera 32 may have a field of view F or line scan direction that extends parallel to the direction P in which the light beam 16 extends.

The light 16 emitted by IR light source 14 is, e.g., at the boundary of visible light. For achieving the best results, the wavelength of the IR-light 16 is 850 nm.

By the method described above, and by using the system 10, best contrast of the glass fibers 22 on top of the carbon fibers 26 are achieved.

In particular, it can be determined whether only one layer or two layers 24 of glass fibers are provided on carbon fiber layer 28. Further, it can be detected by whether there is no layer 24 of glass fibers 22 on top of the carbon fibers 26 or carbon fiber layers 28. Thus, it can be detected whether a glass fiber layer 24 is missing or at a wrong position within the cured composite part 12.

Due to the fact that the IR-light source 14 illuminates the surface 18 at an inclination angle, and camera 32 looks at surface 18 from the same side at an inclination angle to capture images, an influence of the reflection of carbon fibers 26 in the image captured by camera 32 is avoided, which leads to a higher contrast between the glass fibers 22 and the carbon fibers 26.

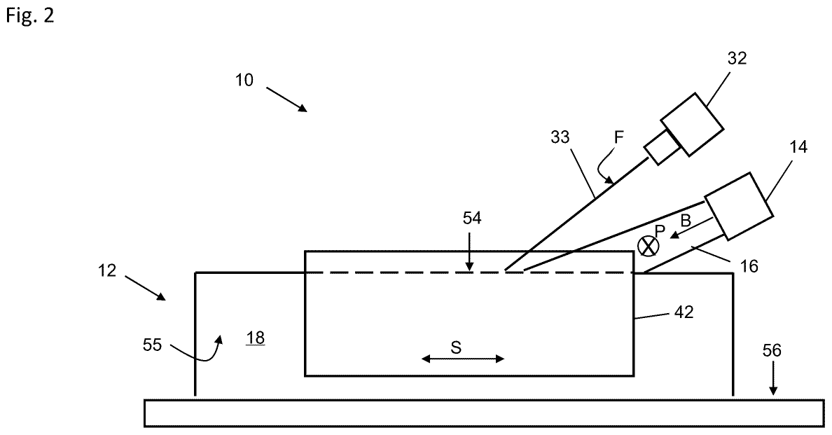

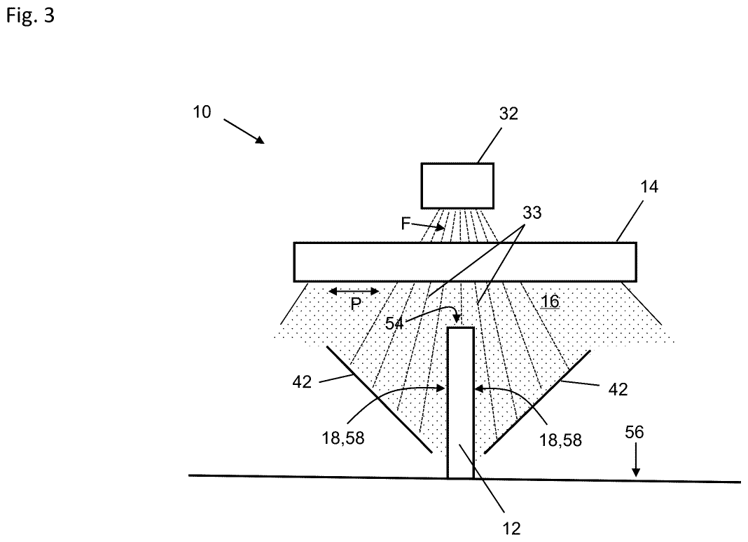

FIGS. 2 and 3 show a second embodiment of the system and method as described above. FIG. 2 shows the system 10 during operation, together with the composite part 12 to be inspected, as a side view similar to that of FIG. 1. FIG. 3 shows the system 10 during operation, together with the composite part 12 to be inspected, as a front view.

In this embodiment, a mirror arrangement comprising two mirrors 42, 44 is additionally provided in system 10. All other features and details of system 10 are the same as in the first embodiment described above with reference to FIG. 1.

In contrast to the method described above with reference to FIG. 1, the composite part 12 to be inspected is vertically arranged in this example, i.e., the inspected surface 18 extends with a spatial component in the direction of the positions of IR-light source 14 and camera 32. IR-light source 14 and camera 32 are both located above a top edge 54 of the composite part 12, wherein the inspected surface 18 of the composite part 12 is located on one or on both sides 55 of the composite part 12.

In other words, the surface 18 to be inspected extends in a plane which is parallel to the viewing direction 33 or optical axis of camera 32, and parallel to the direction B of the IR-light beam 16 emitted from IR-light source 14.

For inspecting the composite part 12 in this example, the IR light source 14 and the IR-camera 32 are arranged as in the example described above with reference to FIG. 1, however the surface 18 to be inspected is oriented vertically, i.e., perpendicular to its orientation shown in FIG. 1.

The infrared light 16 which forms a light beam and which is emitted by IR light source 14 in the beam direction B, extends with a spatial component thereof in a direction P which is perpendicular to the direction B of the emitted IR-light beam 16, and also perpendicular to the inspected surface 18.

Camera 32 has a viewing direction 33 or optical axis and a preferably flat field of view F, or a line scan direction in case of a line scan camera, that extends with a spatial component thereof parallel to the direction P in which the light beam 16 extends.

A mirror 42 is arranged on one side or preferably on both sides 55 of the composite part 12, i.e., of the surface or surfaces 18 to be inspected, so that the IR light 16 emitted by IR-light source 14 is deflected by the mirror 42 to hit or strike the respective surface 18 at the first angle α to provide dark-field illumination of surface 18, and that the viewing direction 33 of the camera 32 is deflected by mirror 42 and directed to the surface 17 to point at the surface 18 at the second angle β.

The surface of each mirror 42 preferably extends with a spatial component S thereof parallel to the surface 10 to be inspected. The IR-light source 14 and the camera 32 are arranged at positions such that they form the angles α and β respectively with respect to that spatial component S.

In the example shown here, in which the composite part 12 with the one or two surfaces 18 is arranged on a base area 56 extending perpendicular to the inspected surfaces 18 of the composite part 12, the angle α at which the infrared light 16 hits or strikes the surface 18, and the angle β at which the camera 32 points at the surface 18, after deflection by mirrors 42, are equal to the respective angles of the IR-light 16 and the camera's 32 viewing direction 33 with the basic surface 56.

All other details and features of the method shown in this example are the same as described above with reference to FIG. 1.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### List of Reference Signs

10 surface inspection system
12 composite part
14 infrared light source
16 infrared light
18 surface
22 glass fibers
24 glass fiber layer
26 carbon fibers
28 carbon fiber layer.
32 camera
33 viewing direction or optical axis of camera
42 mirror
54 top edge
55 sides
56 base area
B direction of the IR-light beam
F Field of view
P extension direction of IR-light beam
S spatial component of mirror parallel to the surface to be inspected
α first angle
β second angle

Claimed is:

1. A method for surface inspection of a cured composite part comprising glass fibers and carbon fibers, the method comprising the steps:
illuminating a surface of a composite part to be inspected with infrared light emitted from an IR light source;
capturing an image of the surface with a camera, wherein IR light source is arranged so that the infrared light hits the surface at a first angle α provide a dark field illumination of the surface, and wherein the camera is arranged so that the camera points at the surface at a second angle β to capture the image of the dark field illuminated surface; and
detecting one or more glass fiber layers on top of one or more carbon fiber layers within the composite part by evaluating the image with regard to brightness and contrast.

2. The method according to claim 1, wherein the IR light source and the camera are arranged in relation to the surface in such a way that the infrared light and the camera are directed at the surface from a same direction.

3. The method according to claim 1, wherein at the first angle is about 30 degrees, or between 25 and 35 degrees, or between 20 and 50 degrees.

4. The method according to claim 1, wherein the second angle β is about 45 degrees, or between 40 and 50 degrees, or between 30 and 60 degrees, or greater than the first angle α.

5. The method according to claim 1, wherein the infrared light emitted by the IR light source forms a light beam emitted in a beam direction and comprises a spatial component that extends perpendicular to the beam direction and parallel to the surface.

6. The method according to claim 5, wherein the camera has a field of view, or a line scan direction, or both that extends parallel to the spatial component of the light beam.

7. The method according to claim 1, wherein the infrared light is at a boundary to visible light, or has a wavelength of about 850 nm, or both.

8. The method according to claim 1, wherein the camera is a monochrome camera, or IR-camera, or both.

9. The method according to claim 1, wherein the camera is a line scan camera.

10. The method according to claim 1, wherein the camera comprises a band filter which allows a band of wavelength around 850 nm pass through or does not comprise a lens filter.

11. The method according to claim 1, wherein the IR light source and the camera are positioned above a top edge of the composite part during inspection, and a mirror is positioned on one or both sides of the composite part so that the mirror deflects the infrared light to strike the surface at the first angle α, the camera being directed to the mirror to point at the surface at the second angle β.

12. A system for surface inspection of a cured composite part comprising glass fibers and carbon fibers, wherein the system comprises:
an IR light source; and
a camera,
both of which are configured to perform the method according to claim 1.
